(19) United States
(12) Patent Application Publication
(10) Pub. No.: US 2021/0068205 A1
(43) Pub. Date: Mar. 4, 2021

(54) Heating Element

(71) Applicant: Vitesco Technologies GmbH, Hannover (DE)

(72) Inventor: Rolf BRÜCK, Schwalbach a. Ts. (DE)

(21) Appl. No.: 16/961,181

(22) PCT Filed: Jan. 9, 2019
(86) PCT No.: PCT/EP2019/050367

§ 371 Date: Jul. 9, 2020

(30) Foreign Application Priority Data
Jan. 12, 2018 (DE) 10 2018 200 463.3

(51) Int. Cl. H05B 3/44; F01N 3/28

(52) U.S. Cl. CPC H05B 3/44; F01N 13/16; F01N 3/281

(57) ABSTRACT

A heating element for heating a component for exhaust gas aftertreatment using ohmic resistance includes: an unheated end region; an intermediate region; and a heated end region. The unheated end region and the heated end region are separated by the intermediate region, and the intermediate region consists of a thermally insulating material configured to minimize heat flow from the heated end region to the unheated end region.

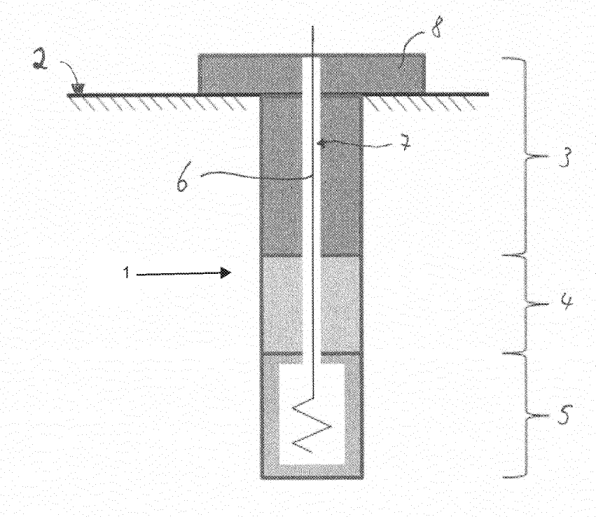

### CROSS REFERENCE TO RELATED APPLICATIONS

This is a U.S. national stage of International application No. PCT/EP2019/050367, filed on Jan. 9, 2019, which claims priority to German Application No. 10 2018 200 463.3, filed Jan. 12, 2018, the content of each of which is incorporated herein by reference.

### BACKGROUND OF THE INVENTION

### 1. Field of the Invention

The invention relates to a heating element for heating a component for exhaust gas aftertreatment using the ohmic resistance.

### 2. Description of the Prior Art

Conductors through which current flows and which produce heat by using the ohmic resistance are known for heating components for exhaust gas aftertreatment. In particular, the prior art includes “heating cartridges”, which are often of cylindrical design and have in the interior a conductor through which current flows.

The disadvantage with the heating cartridges known in the prior art is, in particular, that the heat output takes place in an undifferentiated manner and thus that not only the desired regions in the components for exhaust gas aftertreatment are heated. As a result, losses increase, making heating inefficient. Heat losses are caused, in particular, by the heating of the housing of the component for exhaust gas aftertreatment and by the heating of the housing parts of the heating cartridge.

### SUMMARY OF THE INVENTION

The problem addressed by the present invention is therefore that of providing a heating element that allows selective heating of a component for exhaust gas aftertreatment and thus contributes to minimizing heat losses.

The problem is solved, with regard to the heating element, in accordance with one aspect of the invention, a heating element for heating a component for exhaust gas aftertreatment using the ohmic resistance, wherein the heating element has an unheated end region and a heated end region, wherein the two end regions are separated by an intermediate region, wherein the intermediate region consists of a thermally insulating material in order to minimize any heat flow from the heated end region to the unheated end region.

The thermally insulating intermediate region serves to minimize the heat flow from the heated end region toward the unheated end region and, in a particularly advantageous embodiment, to completely prevent it. The intention is thereby to prevent the heat produced by the heating element from flowing unused to the unheated side of the heating element and being radiated from there into the environment or unintentionally heating surrounding components. These surrounding components can include the housing of a honeycomb body into which the heating element is inserted, for example.

Ideally, the heating element radiates the heat produced by it directly and exclusively into the structure to be heated, e.g., the honeycomb body. In this way, unintentional heat losses are avoided, and the heating of the structures to be heated is thus more efficient.

The heating element can have a housing, in which the thermally insulating material is arranged. In an alternative embodiment, the heating element can also be manufactured completely from the thermally insulating material in the intermediate region.

It is particularly advantageous if the thermally insulating region is formed from a ceramic material, e.g., Al₂O₃. A ceramic material is advantageous since it can be adapted easily to the respective shape requirements and very good thermal insulation can be achieved.

It is also advantageous if the heating element has a channel-type guide through the unheated end region and the intermediate region into the heated end region, through which an electric conductor is passed. In the interior of the unheated region and the intermediate region, these regions ideally have a channel-type guide in order to guide the electric conductor, through which current flows for the purpose of heating, into the heated region. By virtue of the guidance of the electric conductor in the interior of the heating element it is possible to achieve a particularly compact construction of the heating element. At the same time, the electric conductor is protected from damage.

One preferred exemplary embodiment is characterized in that the insulating material which forms the intermediate region is of both thermally insulating and electrically insulating configuration. By virtue of the additional property that the intermediate region also has electrically insulating properties, it is possible to ensure that the heating element is also electrically insulated with respect to the surrounding structures, e.g., the housing of a honeycomb body in which the heating element can be fixed on the unheated end region by an assembly. It is thereby possible to avoid short circuits and energy losses due to misdirected currents.

The electric conductor is preferably electrically insulated with respect to the remainder of the heating element in the interior of the heating element. This applies at least to the region in which the electric conductor is passed through the unheated end region. This is intended to avoid short circuits with the unheated end region and thus also the surrounding structures.

It is also preferable if the heat output from the heated end region toward the environment takes place exclusively in the radial direction of the heating element and in the axial direction away from the intermediate region.

This is advantageous since all the heat produced is thus passed into the structures that are actually supposed to be heated. Heat dissipation toward the unheated end region is prevented or minimized to the greatest possible extent by the thermal insulator in the intermediate region. If the heating element is arranged in a metal honeycomb body, for example, the primary aim is to heat the metal foils forming the flow channels, with the result that it is particularly the regions of the honeycomb body on which catalytic conversion of the exhaust gas flowing past is supposed to take place which are heated.

Moreover, it is advantageous if the heating element has, on the unheated end region thereof, an assembly, by which it can be fixed on the housing of the component for exhaust gas aftertreatment. This is advantageous since the connection between the heating element and the structures surrounding the heating element, e.g., the housing of a honeycomb body, is thus produced at a location at which only a very minimal heat flow or none at all takes place. It is thus possible to minimize the heat losses.

It is furthermore advantageous if the component for exhaust gas aftertreatment is formed by a metal honeycomb body, which has a hollow into which the heating element can be inserted. A metal honeycomb body preferably consists of a plurality of smooth and profiled metal foils that are stacked on top of one another and wound up. By the heating element, which is inserted into a hollow, the metal foils can be heated in a particularly simple and direct way, thus ensuring quick and efficient heating of the honeycomb body.

Advantageous developments of the present invention are described in the following description of the FIGURES.

### BRIEF DESCRIPTION OF THE DRAWINGS

The invention will be discussed in detail below on the basis of an exemplary embodiment and with reference to the drawing. In the drawing:

The FIGURE shows a schematic section through a heating element according to the invention.

### DETAILED DESCRIPTION OF THE PRESENTLY PREFERRED EMBODIMENTS

The FIGURE shows a schematic section through a heating element 1, which is inserted into a honeycomb body 2. Here, the honeycomb body 2 is shown only indicatively, with the metal foils forming the honeycomb structure, in particular, not being illustrated.

The heating element 1 has three regions. The outer unheated end region 3, the intermediate region 4 and the heated end region 5. The intermediate region 4 is formed from a thermally and electrically insulating material, with the result that the heat produced in the heated end region 5 can flow toward the unheated end region 3 only in very small amounts, if at all.

The heated end region 5 is heated by a conductor 6, through which current flows. The conductor 6 through which current flows is also passed through the unheated end region 3 and the intermediate region 4 in a channel-type structure 7. Ideally, the conductor 6 through which current flows is electrically insulated with respect to the unheated end region 3.

The heating element 1 is secured on the housing of the honeycomb body 2 by a flange 8. Thus, no path is formed via which the heat produced by the heating element 1 could flow directly into the housing of the honeycomb body 2 . The heat is discharged from the heated end region 5 substantially in the radial direction toward the honeycomb body 2 or the flow channels (not shown) of the honeycomb body 2. Heat can furthermore be discharged to the honeycomb body 2 in an axial direction of the heating element 1 away from the thermally insulating intermediate region 4.

The thermally insulating properties of the intermediate region 4 interrupt the heat path from the heated end region 5 toward the unheated end region 3.

In the FIGURE, the heating element 1 is represented as a cylindrical body. However, this is only one possible illustrative embodiment. Other geometrical configurations that exhibit the inventive features are also possible.

The exemplary embodiment in the FIGURE is in particular not of a limiting nature, and serves for illustrating the concept of the invention.

Although exemplary embodiments have been discussed in the above description, it should be noted that numerous modifications are possible. Furthermore, it should be noted that the exemplary embodiments are merely examples which are not intended to limit the scope of protection, the applications and the structure in any way. Rather, a person skilled in the art will take from the above description a guideline for implementation of at least one exemplary embodiment, wherein various modifications may be made, in particular with regard to the function and arrangement of the described components, without departing from the scope of protection as can be gathered from the claims and equivalent feature combinations.

1.-7. (canceled)

8. A heating element (1) for heating a component for exhaust gas aftertreatment using ohmic resistance, the heating element (1) comprising:
an unheated end region (3);
an intermediate region (4); and
a heated end region (5),
wherein the unheated end region (3) and the heated end region (5) are separated by the intermediate region (4), and wherein the intermediate region (4) consists of a thermally insulating material configured to minimize heat flow from the heated end region (5) to the unheated end region (3).

9. The heating element (1) as claimed in claim 8, wherein the thermally insulating material is a ceramic material.

10. The heating element (1) as claimed in claim 8, further comprising:
a channel guide (7) arranged through the unheated end region (3) and the intermediate region (4) and into the heated end region (5), and
an electric conductor (6) arranged to pass through the channel guide (7).

11. The heating element (1) as claimed in claim 8, wherein the thermally insulating material is also configured so as to be electrically insulating.

12. The heating element (1) as claimed in claim 8, wherein heat output from the heated end region (5) toward the environment takes place exclusively in a radial direction of the heating element (1) and in an axial direction away from the intermediate region (4).

13. A component (2) for exhaust gas aftertreatment comprising:
a housing; and
the heating element (1) as claimed in claim 8,
wherein the heating element (1) has, on the unheated end region (3) thereof, an assembly (8), configured to affix the heating element (1) on the housing for exhaust gas aftertreatment.

14. The component (2) for exhaust gas aftertreatment as claimed in claim 13, wherein the component (2) is a metal honeycomb having a hollow into which the heating element (1) is insertable.

15. The heating element (1) as claimed in claim 9, wherein the ceramic material is Al₂O₃.
